(19) United States
(12) Patent Application Publication
(10) Pub. No.: US 2008/0040374 A1
(43) Pub. Date: Feb. 14, 2008

(54) AUTOMATED IDENTIFICATION AND TAGGING OF PAGES SUITABLE FOR SUBSEQUENT DISPLAY WITH A MOBILE DEVICE

(75) Inventors: Bangalore Subbaramaiah Prabhakar, Bangalore (IN); Sudhir Kumar Rama Rao, Bangalore (IN); Siddharth Seth, Bangalore (IN); Sundaramoorthy Murugesan, Tamil Nadu (IN)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/611,031

(22) Filed: Dec. 14, 2006

(30) Foreign Application Priority Data
Aug. 4, 2006 (IN) 781/KOL/2006

(51) Int. Cl. G06F 7/00

(52) U.S. Cl. 707/101

(57) ABSTRACT

A system, apparatus, and method are disclosed to identify and tag documents that are mobile documents in that they are compatible with limited capability devices, such as mobile phones. A website hosting a document is checked to determine whether the website considers the document to be a mobile document. The document is also for indications that the document is a mobile document. The indications include a content type, a document type, and/or markup tags that are consistent with a mobile document. A URL for the document is also checked for parameters indicating a mobile document. The above information is used to determine one or more categories of mobile devices that could display or otherwise process the document. A confidence level is determined indicating a degree of confidence that the document is a mobile document. The information is used for searching documents for those that are likely to be mobile documents.

### RELATED APPLICATION

This application claims the benefit of Indian Application Serial No. 781/KOL/2006 filed on Aug. 4, 2006, which is hereby incorporated by reference.

### FIELD OF ART

This invention relates generally to network communications, and more particularly but not exclusively, to automatically identifying and marking web pages and other resources that limited capability devices may display or operate on.

### BACKGROUND

Many mobile computing devices, such as personal digital assistants, cellular phones, and the like, may be employed to communicate voice messages, emails, text messages, and so forth. These limited capability mobile computing devices are becoming increasingly common, and many people are also using these mobile devices to search for information over the Internet. It is not uncommon to see a person on a bus, train, or even a boat, using their mobile device to search for merchants, restaurants, music, or the like. However, accessing such information typically requires conventional web pages and/or conventional web services to be reduced, reformatted, or otherwise specially configured for display or other use by limited capability mobile devices.

Conventional web pages, services and other data are generally designed to be accessed through a larger viewing area with a conventional browser application running on a general purpose computing device. For example, a hypertext markup language (HTML) web page can be displayed with a Mozilla® Firefox® browser running on a personal computer. However, many web pages, documents, or other web data, which may be used for presentation of data across the network or within a system, cannot be viewed with limited capability devices such as a mobile phone. A corresponding limited capability browser, such as Opera Mini™ from Opera Software ASA, has limited capabilities when compared to a conventional desktop browser. Mobile device browsers generally cannot handle pages with complex components, like multiple tables, embedded videos and flash, frames, etc.

Mobile web data may be stored separately from, or dynamically generated from, conventional web pages and/or web services. However, the mobile web data may also be stored together with conventional web data. The mobile web data may not be identified as such to web crawlers or other systems accessing data of a web site. For example, if the web site returns a page when a crawler tries to access that page from a mobile device, the page is not always a mobile page that can be viewed with the mobile device.

Also, mobile web pages and other mobile web data typically have less metadata, less content, less overall quantity, and less accessibility. A consequence is that mobile web data is generally not as well interrelated, not as well organized, and not as easy to identify. In addition, the formatting and structure of mobile web data is generally incompatible with general purpose browsers, and conventional web data is generally incompatible with mobile device browsers. For example, many mobile devices use a wireless application protocol (WAP) and display wireless markup language (WML) web pages that are not compatible with conventional browsers that operate on a PC. Worse yet, naming conventions may be inconsistent between mobile web sites, mobile web pages, mobile web services, and other mobile web data. Creators of documents and/or other web data which is meant for mobile devices, often do not adhere to a single format or single document type. Hence there are wide varieties of documents which can be viewed in mobile devices. Some information on designing mobile web pages is available from the Open Mobile Alliance (OMA) and the World Wide Web Consortium (W3C). With these limitations, it may be difficult to identify and locate information that is accessible with only a limited capability mobile device.

At present, applicants are not aware of an algorithm to determine whether a page can be viewed with a limited capability device, such as on a mobile phone. Accordingly, there is a need in the industry to provide an improved mechanism for identifying and marking web content that is accessible with a limited capability device. It is with respect to these considerations and others that the present invention has been made.

### BRIEF DESCRIPTION OF THE DRAWINGS

Non-limiting and non-exhaustive embodiments of the invention are described with reference to the following drawings. In the drawings, like reference numerals refer to like parts throughout the various figures unless otherwise specified.

For a better understanding of the invention, reference will be made to the following Detailed Description of the Invention, which is to be read in association with the accompanying drawings, wherein:

FIG. 1 shows a functional block diagram illustrating one embodiment of an environment for performing mobile web searching;

FIG. 2 shows one embodiment of a server device that may be included in a system implementing the invention;

FIG. 3 shows a functional block diagram illustrating one embodiment of components for use in analyzing data in a network to identify and mark data that can be used with a limited capability device; and

FIG. 4 illustrates a logical flow diagram generally showing one embodiment of an overview process for identifying and marking data in a network that can be used with a limited capability device, in accordance with various embodiments.

### DETAILED DESCRIPTION OF THE INVENTION

Embodiments of the present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” or “in an example embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In this specification, the term “client” refers to a computing module's general role as a requester of data or services, and the term “server” refers to a computing module's role as a provider of data or services. In general, it is possible that a computing module can act as a client, requesting data or services in one transaction and act as a server, providing data or services in another transaction, thus changing its role from client to server or vice versa.

The term “URL” generally refers to a uniform resource locator, but may also include a uniform resource identifier and/or other address information. A URL generally identifies a protocol, such as hypertext transfer protocol (e.g., “http://”), a host name (e.g., “news.yahoo.com,” “sports.yahoo.com,” “travel.yahoo.com,” “entertainment.yahoo.com,” etc.) or a domain name (e.g., “yahoo.com”), a path (e.g., “/mobile/bbc_news/politics”), and a query string (e.g., “?d=quot”) or a specific file (e.g., “story5228782.wml”).

The term “mobile web” generally refers to a collection of devices, data, and/or other resources that are accessible over a network according to one or more protocols, formats, syntax, and/or other conventions that are intended for use with specialized or otherwise limited capability devices, such as mobile phones, personal digital assistants (PDAs), palm-top computers, portable music devices, and the like. Mobile web protocols include, but are not limited to, the wireless application protocol (WAP). Such conventions include, but are not limited to, wireless markup language (WML) and extensible hypertext markup language (XHTML). The terms “mobile web page” and “mobile web data” generally refer to a document, file, application, service, and/or other data that conforms to mobile web conventions and is generally accessible with a limited capability device running a limited capability application such as a micro browser. Example micro browsers include Explorer Micro™ from Microsoft Corporation, Opera Mini™ from Opera Software ASA, and Fusion WebPilot™ from DSPOS, Inc.

The term “conventional web” generally refers to a collection of devices, data, and/or other resources that are accessible over a network according to one or more protocols, formats, syntax, and/or other conventions that are intended for use with general purpose devices, such as personal computers, laptop computers, workstations, servers, mini computers, mainframes, and the like. Conventional web protocols include, but are not limited to, the hypertext transfer protocol (HTTP). Such conventions include, but are not limited to, hypertext markup language (HTML) and extensible markup language (XML). The terms “conventional web page” and “general web data” generally refer to a document, file, application, service, and/or other data that conforms to conventional web conventions and is generally accessible with a general purpose computing device running a full capability application such as a general purpose browser. Example general purpose browsers include Internet Explorer™ from Microsoft Corporation, Netscape™ from Netscape Communications Corp., and Firefox™ from the Mozilla Foundation. Conventional web pages are generally indexed by search engines that are able to access conventional web pages, but may have limited, or no ability to access mobile web pages. An example search engine is Yahoo Search™ by Yahoo, Inc.

Briefly stated, the invention is directed towards a system, apparatus, and method for identifying and marking web data as accessible by limited capability devices such as cellular telephones. This will enable easier and faster access to mobile web data with limited capability devices.

### Illustrative Operating Environment

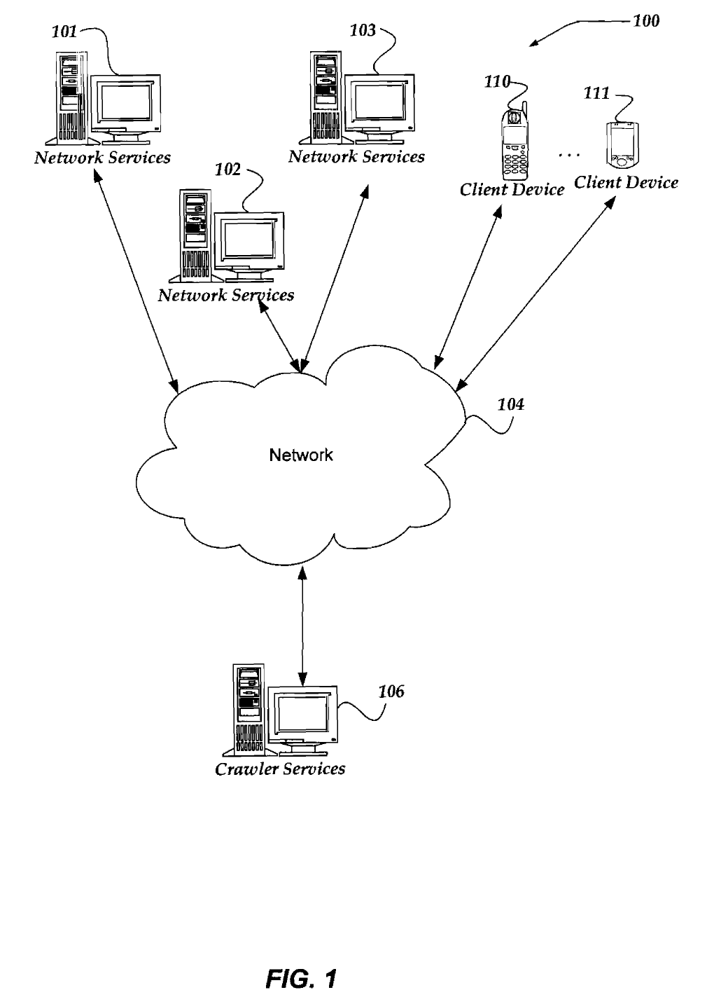

FIG. 1 illustrates one embodiment of an environment in which the invention may operate. However, not all of these components may be required to practice the invention, and variations in the arrangement and type of the components may be made without departing from the spirit or scope of the invention.

As shown in the figure, system 100 includes domain sites 101-103, client devices 110-111, a network 104, and a Crawler Server 106. Network 104 is in communication with and enables communication between each of domain sites 101-103, client devices 110-111, and MSS server 106.

Client devices 110-111 may include virtually any computing device capable of receiving and sending a message over a network, such as network 104, to and from another computing device, such as domain sites 101-103, each other, and the like. The set of such devices generally includes mobile devices that are usually considered more specialized devices with limited capabilities and typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. However, client devices 110-111 may be any device that is capable of connecting using a wired or wireless communication medium such as a personal digital assistant (PDA), POCKET PC, wearable computer, and any other device that is equipped to communicate over a wired and/or wireless communication medium. The set of client devices may also include devices that are usually considered more general purpose devices and typically connect using a wired communications medium at one or more fixed location such as laptop computers and the like. Such general purpose devices may communicate with the limited capability devices, such as through a translation service.

Each client device within client devices 110-111 may include a user interface that enables a user to control settings, and to instruct the client device to perform operations. Each client device also includes a client user-agent that enables the client device to send and receive messages to/from another computing device employing the same or a different communication means, including, but not limited to SMS, MMS, IM, internet relay chat (IRC), Mardam-Bey's internet relay chat (mlRC), Jabber, email, and the like.

Client devices 110-111 may be further configured with a browser application that is configured to receive and to send content in a variety of forms, including, but not limited to markup pages, web-based messages, audio files, graphical files, file downloads, applets, scripts, and the like. The browser application may be configured to receive and display graphics, text, multimedia, and the like, employing virtually any mobile markup based language or Wireless Application Protocol (WAP), including, but not limited to a Handheld Device Markup Language (HDML), such as Wireless Markup Language (WML), WMLScript, JavaScript, EXtensible HTML (XHTML), or the like. General purpose client devices may use a browser application configured to receive and display graphics, text, multimedia, and the like, employing virtually any conventional markup based language or conventional web protocol, including, but not limited to Standard Generalized Markup Language (SGML), HyperText Markup Language (HTML), Extensible Markup Language (XML), and the like. The browser application is another example, of a user-agent.

Because each client device within client devices 110-111 may vary in size, shape, and capabilities, client devices 110-111 may also be configured to provide device profile information about its capabilities including whether the client device is capable of receiving particular types of audio files, graphical files, web-based files, and the like. Client devices 110-111 may also provide device profile information that may include an available application on the client device, version information, and other information about the device. In one embodiment, such information may include information such as the client device's network protocol capabilities. Various client applications may employ different network protocols. Thus, in one embodiment, a mobile device profile can also be used to obtain a mobile client's user-agent capabilities. For example, a user-agent capability may be obtained based, in part, on information in a standardized user-agent profile, such as that defined by the User-agent Profile Specification available from the Wireless Application Protocol Forum, Ltd., Composite Capability/Preference Profiles (CC/PP), defined by the World Wide Web Consortium, or the like. A user-agent profile may include a device model number, serial number, display resolution, memory size, processor identifier, operating system identifier, network protocol identifier, and the like.

Client devices 110-111 may also provide an identifier. The identifier may employ any of a variety of mechanisms, including a device model number, a carrier identifier, a mobile identification number (MIN), and the like. The MIN is often a telephone number, a Mobile Subscriber Integrated Services Digital Network (MS-ISDN), an electronic serial number (ESN), or other device identifier. In one embodiment, the identifier, and the device profile information is sent with each message to another computing device. However, the invention is not so limited, and the identifier and device profile information may be sent based on a request for such information, an event, or so forth.

Network 104 is configured to couple one computing device to another computing device to enable them to communicate. Network 104 is enabled to employ any form of medium for communicating information from one electronic device to another. Also, network 104 may include a wireless interface, such as a cellular network interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize cellular telephone signals over air, analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 104 includes any communication method by which information may travel between client devices 110-11, domain sites 101-103, and/or crawler 106. Network 104 is constructed for use with various communication protocols including wireless application protocol (WAP), transmission control protocol/internet protocol (TCP/IP), code division multiple access (CDMA), global system for mobile communications (GSM), and the like.

The media used to transmit information in communication links as described above generally includes any media that can be accessed by a computing device. Computer-readable media may include computer storage media, wired and wireless communication media, or any combination thereof. Additionally, computer-readable media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wireless media such as acoustic, RF, infrared, and other wireless media, and wired media such as twisted pair, coaxial cable, fiber optics, wave guides, and other wired media.

Domain servers 101-103 include virtually any network device that may be configured to provide content over a network. In one embodiment, domain servers 101-103 are configured to operate as a website server. Thus, in one embodiment, domain servers 101-103 may provide access to content using a domain name. Moreover, such content may typically be configured for viewing using a variety of user-agents, including web browsers, or the like. Some of the content may be configured to be specifically viewable by mobile user-agents, while other content may be un-viewable by mobile user-agents. In one embodiment, some of the content may be viewable by particular mobile user-agents, while un-viewable by another mobile user-agent. In one embodiment, domain servers 101-103 may organize at least some of its content based on a host name.

Domain servers 101-103 are not limited to web servers, and may also operate a conventional web search server, a messaging server, a File Transfer Protocol (FTP) server, a database server, application server, and the like. Devices that may operate as domain servers 101-103 generally include personal computers desktop computers, multiprocessor systems, microprocessor-based or programmable consumer electronics, network PCs, servers, and the like. However, limited capability devices may be able to access some information and/or services from domain servers 101-103.

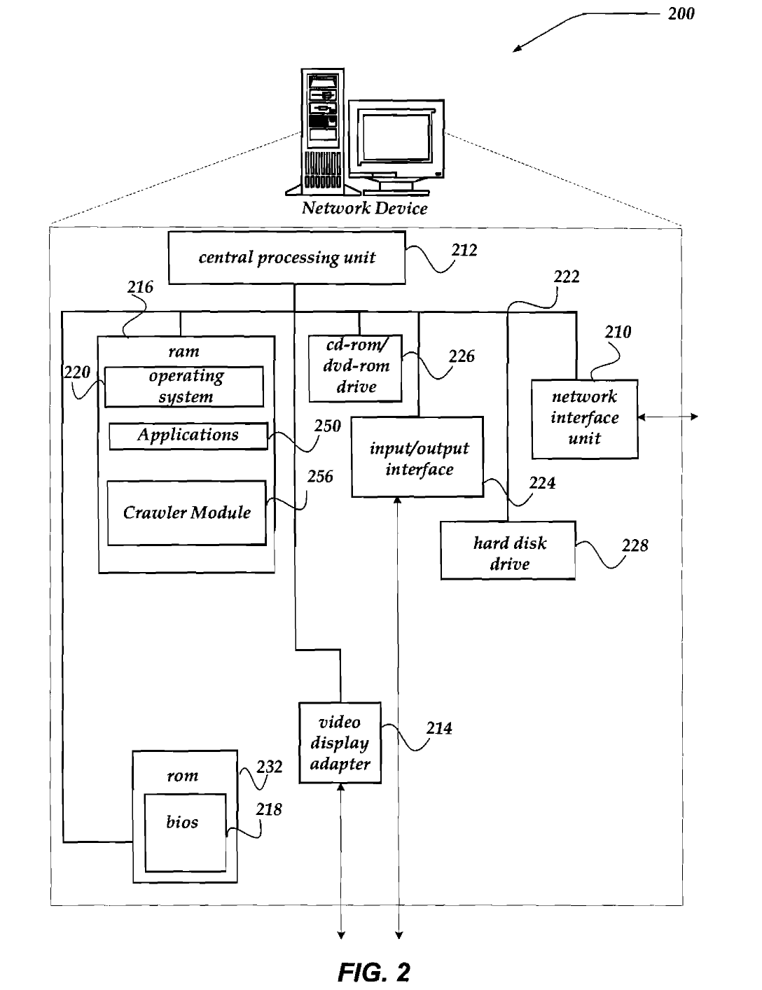

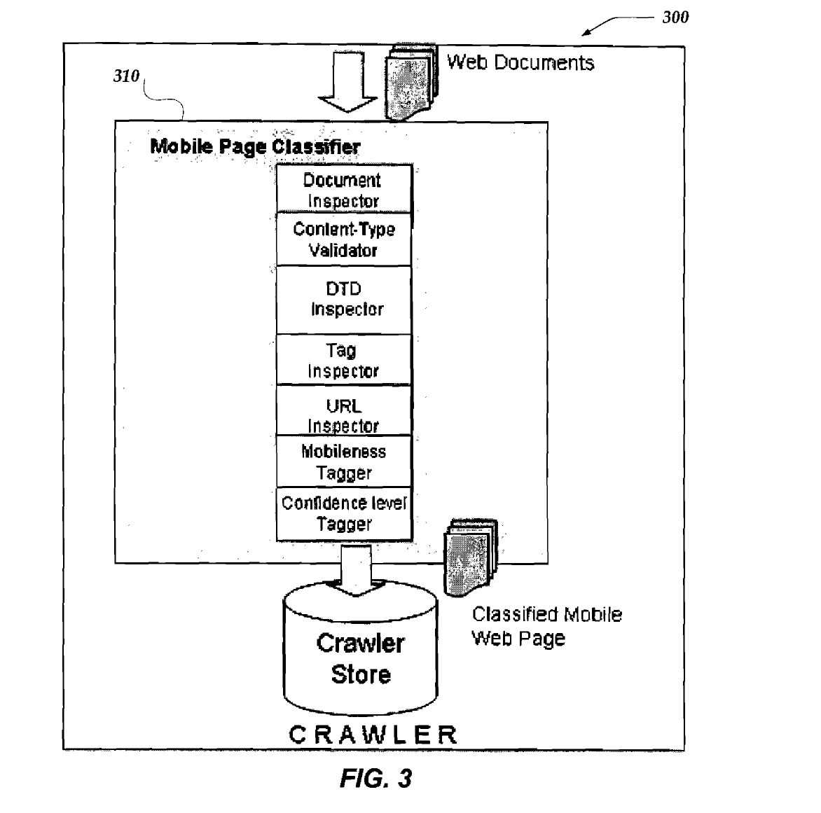

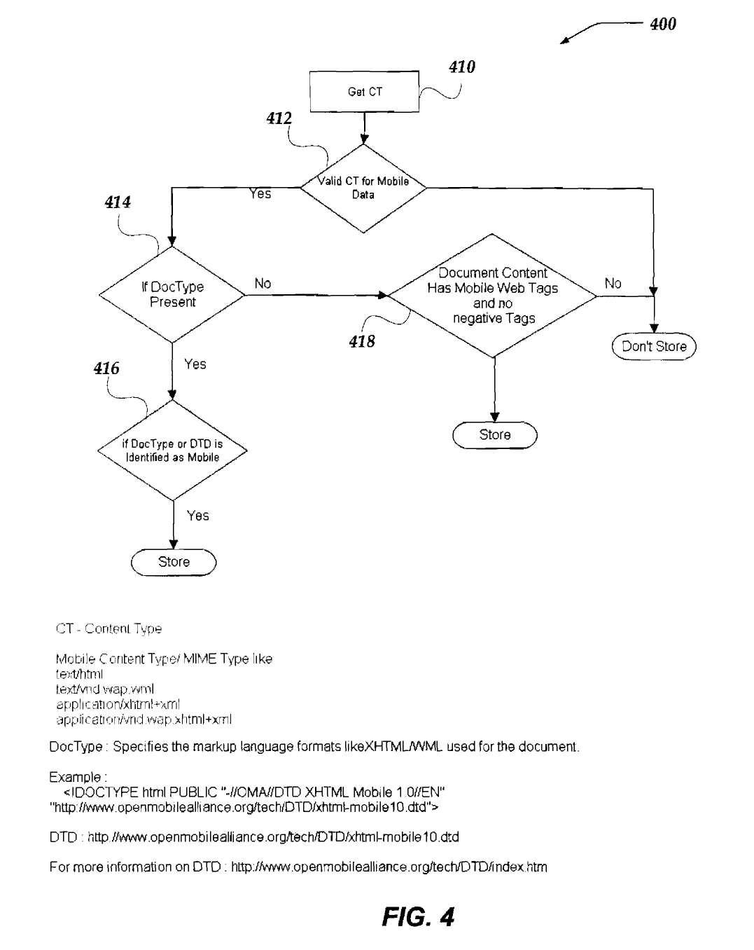

One embodiment of crawler server 106 is described in more detail below in conjunction with FIGS. 2-3. Briefly, however, crawler server 106 includes virtually any network device that may be configured to provide search index for mobile web data. Crawler server 106 may employ a web crawler to locate at least some potentially useable mobile web data. Moreover, in one embodiment, crawler server 106 may perform at least some of its actions using a process substantially similar to that described below in conjunction with FIG. 4.

Although crawler server 106 is illustrated as a single network device, the invention is not so limited. For example, crawler server 106 may be implemented using several network devices, without departing from the scope of the invention. Devices that may operate as crawler server 106 include personal computers desktop computers, multiprocessor systems, microprocessor-based or programmable consumer electronics, network PCs, servers, and the like.

### Illustrative Server Device

FIG. 2 shows one embodiment of a network device, according to one embodiment of the invention. Network device 200 may include many more or less components than those shown. For example, network device 200 may operate as a network appliance without a display screen. The components shown, however, are sufficient to disclose an illustrative embodiment for practicing the invention. Network device 200 may, for example, represent crawler server 106 of FIG. 1.

Network device 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of network device 200. Any general-purpose operating system may be employed. Basic input/output system (“BIOS”) 218 is also provided for controlling the low-level operation of network device 200. As illustrated in FIG. 2, network device 200 also can communicate with the Internet, or some other communications network, via network interface unit 210, which is constructed for use with various communication protocols including the TCP/IP protocol. Network interface unit 210 is sometimes known as a transceiver, transceiving device, network interface card (NIC), or the like.

Network device 200 may also include an SMS handler and/or other mobile messaging handler for transmitting and receiving messages to and from limited capability devices, such as search requests from cell phones. Network device 200 may also include an SMTP handler application for transmitting and receiving email. Network device 200 may also include an HTTP handler application for receiving and handing HTTP requests, and an HTTPS handler application for handling secure connections. The HTTPS handler application may initiate communication with an external application in a secure fashion.

Network device 200 also may include input/output interface 224 for communicating with external devices, such as a mouse, keyboard, scanner, or other input devices not shown in FIG. 2. Likewise, network device 200 may further include additional mass storage facilities such as CD-ROM/DVD-ROM drive 226 and hard disk drive 228. Hard disk drive 228 is utilized by network device 200 to store, among other things, application programs, databases, or the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs include email programs, schedulers, calendars, transcoders, database programs, word processing programs, spreadsheet programs, security programs, web servers, web crawlers, and so forth. Mass storage may further include applications such as Crawler Module (CM) 256.

CM 256 is described in more detail below in conjunction with FIG. 3. Briefly, however, CM 256 is configured to search domains, host sites, and other web sites to identify and mark (tag) web pages and other web data that are viewable, or otherwise usable by one or more limited capability devices. Although CM 256 is illustrated as a single component, the invention is not so limited. CM 256 may, in another embodiment, be implemented as distinct components, as illustrated in FIG. 3, and/or across one or more network devices, such as network device 200. Moreover, CM 256 may employ processes such as described below in conjunction with FIG. 4 to perform at least some of its actions.

### Illustrative Architecture

FIG. 3 shows a functional block diagram 300 illustrating one embodiment of components for use in identifying and marking web data that can be viewed or otherwise used by one or more limited capability devices, such as cellular phones. The components may be combined and executed on a single machine, executed as separate modules on a single machine, and/or distributed over many machines. The components may operate in the sequence shown or in various combinations of other sequences. In this example embodiment, a Mobile Page Classifier (MPC) 310 comprises a pipeline of inspector modules and tagger modules to access and analyze web documents 305 to identify those that can be viewed by limited capability mobile devices. This may be referred to as finding a way to determine the Mobileness of a document, and tagging a given document to indicate which category of mobile devices that can display the given document. In other words, this embodiment provides a method and system to classify and tag a document, web page, or other web data about its “Mobileness.” Determination of Mobileness of a document will not necessarily identify which kind of mobile devices can display a given a document. However, analysis enables tagging of the document to indicate one or more categories of mobile devices that should be able to display the document.

Document Inspector:

One component comprises a document inspector 312 that attempts to determine whether a document is already accessible with a mobile user-agent. If a mobile user-agent 313, or a server module acting as a mobile user-agent, tries to access a website document, in some cases the website will interpret that the request is from a mobile device and provide a document that is understandable to the mobile device. If the website provides such a document, the document inspector sets a document inspector flag, indicating that the website recognized the request as one for a document that is compatible with mobile devices. A URL, another document identifier, and/or a copy of the document may be tagged with an indication that the website thinks the document should be displayable by a mobile device. However, this test may not conclusively prove that the document can actually be displayed by a mobile device. In any case, the document inspector flag and tag may be temporarily stored in active memory and/or stored in a database, such as a crawler store 340.

### Content Type (MIME Type) Inspector:

Another component comprises a content type inspector 314 that attempts to identify the content-type of a given document. The content type may be indicated by a multipurpose internet mail extensions (MIME) type. Generally, there are specific types of content that a mobile device can understand and this stage tries to identify the same. For example, wireless markup language content identified by a content type of “text/vnd.wap.wml” is usually understood by many mobile devices. Such content types may be considered “valid” content types for being displayable or otherwise usable by at least some mobile devices. Examples of “valid” content types may include:
text/html
text/vnd.wap.wml
application/xhtml+xml
application/vnd.wap.xhtml+xml
   If the content type inspector detects a valid content type for a document, the content type inspector sets a content type flag, indicating that the document has a content type that is compatible with mobile devices. The URL, other document identifier, and/or the copy of the document may be tagged with an indication that the document has a content type that is compatible with mobile devices.

However there are also generic content-types that do not indicate mobile content or can be considered to indicate both mobile content as well as conventional web content. For example, a content type of “text/html” may be understood by both mobile devices and general purpose PCs. Some may be tagged as valid if they are generally understood by mobile devices. While other content types may be tagged as valid only for certain classes of mobile devices.

Similarly, some content types may be tagged as not valid for all, or certain other classes of mobile devices. Examples of “invalid” content types may include:

text/css

image/jpeg

image/bmp

image/gif

application/x-shockwave-flash

### In any case, the content type flag and tag may be temporarily stored in active memory and/or stored in a database.

DTD Inspector:

Another component comprises a document type definitions (DTD) inspector 316 that inspects a document type (e.g., DocType) of a current document and/or the DTD that the current document points to. According to the OMA, a mobile document's Doctype has a valid DTD for it to be identified as a mobile viewable page. An example of Valid Doctype is:

<!DOCTYPE html PUBLIC “-//WAPFORUM//DTD XHTML Mobile 1.0//EN” “http://www.wapforum.org/DTD/xhtml-mobile10.dtd”>

This Doctype has mobile keywords such as “XHTML Mobile,” and the DTD it is pointing to is “xhtml-mobile10.dtd.” Another example of valid DTD is:

<!DOCTYPE wml PUBLIC “-//WAPFORUM//DTD WML 1.1//EN” “http://www.wapforum.org/DTD/wml_{—}1.1.xml”>

This Doctype has mobile keywords such as “wml” and the DTD “wml_{—}1.1.xml” is a valid mobile document DTD. If the DTD inspector detects a valid document type, the DTD inspector sets a DTD inspector flag, indicating that the document has a document type that is compatible with mobile devices, or certain classes of mobile devices. The URL, other document identifier, and/or the copy of the document may be tagged with an indication that the document has a document type that is compatible with mobile devices.

An example of an Invalid Doctype, indicating that the document is not displayable with a mobile device, is:

<!DOCTYPE HTML PUBLIC “-//W3C//DTD HTML 4.01 Transitional//EN”

This doctype does not have any mobile keywords. Instead this doctype identifies a conventional web page DTD. For instance, “HTML Public” is a conventional browser webpage DTD. Another example of an Invalid DTD is:

<!DOCTYPE HTML PUBLIC “-//W3C//DTD HTML 4.01//EN”“http://www.w3.org/TR/html4/strict.dtd”>

### Here “strict.dtd” is not a mobile compatible DTD. In any case, the DTD inspector flag and tag may be temporarily stored in active memory and/or stored in a database.

Tag Inspector:

Another component comprises a tag inspector 320 that attempts to determine whether tags, such as markup tags, within the document are associated with a markup language that can be interpreted by mobile devices or certain classes of mobile device. Such languages may include extensible hypertext markup language (xhtml) and wireless markup language (wml). Markup tags in the document that are considered “valid,” may also be called positive tags. Examples of valid markup tags include:

wml

card

do

If the tag inspector detects a valid markup tag in a document, the tag inspector sets a tag inspector flag, indicating that the document has one or more markup tags that are compatible with mobile devices. The URL, other document identifier, and/or the copy of the document may be tagged with an indication that the document has one or more markup tags that are compatible with mobile devices.

Conversely, markup tags in the document that are considered “invalid,” may also be called negative tags. If the document includes negative tags, it is unlikely that the document could be displayed on a mobile device or certain classes of mobile devices. Inspecting the markup tags generally involves parsing through the contents of the document and identifying positive and negative tags in the given document. Examples of invalid tags include:

frame

iframe

object

### In any case, the tag inspector flag and tag may be temporarily stored in active memory and/or stored in a database.

URL Inspector:

Another component comprises a URL inspector 322 that analyzes the URL of a given document to determine whether the URL gives an indication that the document is compatible with mobile devices. The URLs for some mobile compatible documents have certain conventions such as the presence or location of certain parameters. For example, URLs that include the words “WAP” or “xhtml” generally indicate that the corresponding documents are compatible with mobile devices. If the URL inspector detects a valid URL parameter, the URL inspector sets a URL inspector flag, indicating that the URL indicates that a document is compatible with mobile devices or certain classes of mobile devices. The URL, other document identifier, and/or the copy of the document may be tagged with an indication that the URL has one or more parameters indicating that the document is compatible with mobile devices or certain classes of mobile devices.

The URL inspector component may apply certain heuristics to decide and/or add more intelligence to a Mobileness tagger (discussed below) to identify weather a given document is displayable by a mobile device. Some of the heuristics may include:

Checking the host name for valid mobile keywords

Checking the path for a valid mobile content keyword

Checking the file name extension of the current document for a valid keyword

### In any case, the URL inspector flag and tag may be temporarily stored in active memory and/or stored in a database.

### Mobileness Tagger:

Another component comprises a mobileness tagger 324 that attempts to identify categories and/or individual devices that display a given document. Even if the above components indicate that a given document is mobile displayable by at least some mobile devices, it is desirable to categorize the document according to the kind of mobile devices that can display the document. Mobile devices can fall into categories, such as a category of mobile devices that support only wml. Another category may be those mobile devise that supports both wml and xhtml.

Therefore, in addition to determining whether a document is a mobile document, it is desirable to tag the document according to one or more categories of devices that can display the document. This may be accomplished by analyzing the inspection characteristics discussed above and comparing those inspection characteristics with category characteristics. Similarly, the Mobileness tagger component may also identifying individual mobile device models that can display the current document. The categories, models, and/or other device information may be temporarily stored in active memory and/or stored in a database. This information may also be used later in a search.

Confidence Level Tagger:

Another component comprises a confidence tagger 326 that determines a confidence level that a given document is displayable by mobile devices. At each component in the pipeline (other than when we encounter negative tags/identifiers), the document may be given a score which is then aggregated in the confidence level tagger component. For various embodiments, each score may, or may not be weighted. Aggregation may include summing the scores, using one or more thresholds to determine a confidence level, using statistical methods, and/or other techniques for assessing a confidence in data.

An aggregated score of a document can be compared with one or more confidence level thresholds to determine a confidence level that the current document belongs to. Example confidence levels may include low confidence, medium confidence, and high confidence. The confidence and/or other confidence information may be temporarily stored in active memory and/or stored in a database. The confidence level may also be viewed in the search result. Documents, document identifiers, flags, and/or other document data 330 may be stored in database 340.

### Illustrative Logic

FIG. 4 illustrates a logic flow diagram 400 generally showing one embodiment of an overview process for identifying and tagging a document as compatible with limited capability devices. Each illustrated block generally corresponds to an operation performed by one or more software and/or hardware modules, but may include manual operations. Other blocks associated with the components described above may be included in other embodiments.

At a block 410, the content type inspector accesses a content type associated with a document. At a decision block 412, the content type inspector determines whether the content type is valid for at least some mobile devices. If the content type is not valid, the content type inspector may not store the document, a content type inspector flag, or other indication of the content type for this document. In one embodiment, the evaluation of the document may terminate without further analysis of the document.

If the content type is valid, the DTD inspector determines, at a decision block 414, whether a document type is present in the document. If a document type is not present, the tag inspector determines, at a decision block 418, whether the document includes any markup tags. If the document includes markup tags, the tag inspector also determines whether any of the markup tags are negative tags. If the document includes negative tags, the tag inspector may not store the document, a tag inspector flag, and/or other indication of markup tags in this document. In one embodiment, the evaluation of the document may terminate without further analysis of the document. However, if the document includes positive tags, the tag inspector may store the document, a positive tag inspector flag, and/or other indication of positive markup tags in this document, at an operation 420.

Returning to decision block 414, if the DTD inspector determines that a document type is present in the document, the DTD inspector then determines, at a decision block 416, whether the document has a valid document type. If the document has a valid document type, the DTD inspector may store the document, a DTD inspector flag, and/or other indication of a valid document type for this document, at operation 420. Conversely, if the document does not have a valid document type, the DTD inspector may not store the document or other information.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent is:

1. A method for identifying a document, comprising:
requesting the document from a website that enables access to the document over an electronic network;
determining whether the website indicates that the document is displayable with limited capability devices; and
identifying the document as displayable with limited capability devices, if the website does not indicate that the document is displayable with the limited capability devices.

2. The method of claim 1, wherein requesting the document comprises communicating a request to the website, indicating that the document is requested for a limited capability device.

3. The method of claim 1, wherein determining whether the website indicates that the document is displayable, comprises at least one of the following:
receiving no response from the website;
receiving the document in a format that is displayable by limited capability devices; and
receiving the document in a format that is not displayable by limited capability devices.

4. The method of claim 1, wherein identifying the document as displayable, comprises inspecting the document for a content type that indicates the document is displayable with limited capability devices.

5. The method of claim 1, wherein identifying the document as displayable, comprises inspecting the document for a document type indicating that the document is displayable with limited capability devices.

6. The method of claim 1, wherein identifying the document as displayable, comprises inspecting the document for tags indicating that the document is compatible with limited capability devices.

7. The method of claim 1, wherein identifying the document as displayable, comprises inspecting a uniform resource locator (URL) associated with the document for an indication that the document is displayable with limited capability devices.

8. The method of claim 1, further comprising determining a category of limited capability devices with which the document is displayable.

9. The method of claim 1, further comprising determining a confidence level that indicates a degree of confidence that the document is displayable with limited capability devices.

10. The method of claim 1, further comprising storing an indicator in a search index, indicating that the document is displayable with limited capability devices.

11. A computer readable storage medium storing executable instructions for performing the actions of claim 1.

12. An apparatus for identifying a document, comprising.
a communication interface in communication with an electronic network;
a processor in communication with the communication interface; and
a memory in communication with the processor and storing instructions that cause the processor to perform a plurality of actions, including:
requesting the document from a website that provides the document over the electronic network;
determining whether the website indicates that the document is displayable with limited capability devices; and
identifying the document as displayable with limited capability devices, if the website does not indicate that the document is displayable with the limited capability devices.

13. The apparatus of claim 12, wherein the instructions further cause the processor to perform the action of inspecting the document for a content type that indicates the document is displayable with limited capability devices.

14. The apparatus of claim 12, wherein the instructions further cause the processor to perform the action of inspecting the document for a document type indicating that the document is displayable with limited capability devices.

15. The apparatus of claim 12, wherein the instructions further cause the processor to perform the action of inspecting the document for tags indicating that the document is compatible with limited capability devices.

16. The apparatus of claim 12, wherein the instructions further cause the processor to perform the action of inspecting a uniform resource locator (URL) associated with the document for an indication that the document is displayable with limited capability devices.

17. The apparatus of claim 12, wherein the instructions further cause the processor to perform the action of determining a category of limited capability devices with which the document is displayable.

18. The apparatus of claim 12, wherein the instructions further cause the processor to perform the action of determining a confidence level that indicates a degree of confidence that the document is displayable with limited capability devices.

19. The apparatus of claim 12, wherein the apparatus comprises one of the following: a server and a mobile device.

20. A system for identifying a document, comprising:
a user-agent that sends a request to a website for a document, the request indicating that it came from a limited capability device;
a classifier in communication with the user-agent, wherein the classifier performs a plurality of operations, including:
determining whether the website indicates that the document is displayable with limited capability devices; and
identifying the document as displayable with limited capability devices, if the website does not indicate that the document is displayable with the limited capability devices.
